(19) United States
(12) Patent Application Publication
(10) Pub. No.: US 2009/0162718 A1
(43) Pub. Date: Jun. 25, 2009

(54) Low Impurity Elastomeric Material

(76) Inventor: Charles W. Extrand, Minneapolis, MN (US)

Correspondence Address: John W Pillion;Entegris, 129 Concord Road, Billerica, MA, 01821-4600, US

(21) Appl. No.: 12/083,570

(22) PCT Filed: Nov. 30, 2006
(86) PCT No.: PCT/US2006/045813

§ 371 Date: Apr. 15, 2008

Related U.S. Application Data
(60) Provisional application No. 60/742,042, filed on Dec. 2, 2005.

(51) Int. Cl. H01M 8/10; C08K 3/04

(52) U.S. Cl. 429/30; 524/571; 524/570

(57) ABSTRACT

Embodiments of the present invention include cured elastomeric materials of high purity, compositions for making them, and articles comprising the cured elastomeric materials. Embodiments of the invention include cured elastomers that have less than 200 ng/cm2 of calcium. In some embodiments, the cured elastomer is made from cross linked ethylene-propylene-diene terpolymers and can be free from cross linked fluorpelastomers or silicone elastomers. The cured elastomers in embodiments of the present invention may be used for seals including o-rings and gaskets.

This Application claims the benefit of U.S. Provisional Application No. 60/742,042 filed Dec. 2, 2005, the contents of which are incorporated by reference in their entirety into the present application.

A fuel cell receives through separate conduits a hydrogen containing fuel gas typified by hydrogen, methanol, or other fuel, a source of oxygen such as air, and a cooling fluid typified by water or glycol. In the fuel cell the source of hydrogen from the fuel gas is allowed to react with the oxygen source through electrodes and an intervening electrolyte to generate an electric current.

In general, each “cell” of a fuel cell includes a pair of porous bipolar plates or collector separator electrodes and a pair of membrane and electrode assemblies (MEAs). Each MEA can include a polymer electrolyte membrane, a catalytic layer, and a reactive electrode layer. The MEA can be sandwiched between the two bipolar plates. The bipolar plates are typically sealed to the assembly, the seals have low permeation to reduce evaporation of water and drying of the polymer electrolyte membrane. Easy assembly and disassembly of the seals is beneficial. Several adjacent cells form a fuel cell stack. Sealing between fuel cell stacks can be accomplished using gaskets. Since a large area is sealed in a fuel cell stack, a large compressive force may be used to seal the fuel cell assembly. The compressive force of sealing can change as the compressed height of the seal changes slightly during use and over time which can compromise the seal.

A single cell in the fuel cell is generally structured with electrodes fitted to it, the electrodes can be formed by coating a catalyst such as platinum or other suitable material on both sides of a plate like electrolyte. The two electrodes are further connected to externally disposed electrical conductors. Electricity generation is performed with the fuel gas supplied to one such electrode, i.e., a negative pole, and with the air supplied to the other, i.e., a positive pole. More specifically, the fuel gas is decomposed by the action of the catalyst into hydrogen ions, i.e., protons, and electrons at the negative pole so that the hydrogen ions migrate to the positive pole after passage through the electrolyte, and the electrons flow to the positive pole after passage through the external conductors. At the positive pole, the oxygen containing gas can be catalytically reacted with the hydrogen ions and electrons that have passed to that pole whereby water is produced.

Ionic contamination from gaskets, seals, supply pipes, exhaust pipes and the like, or from fluids such as a fuel gas or oxidant can contaminate the electrolyte and or catalyst in the fuel cell, thereby causing failure in the proper migration of hydrogen ions, decomposition of fuel gas and production of water during electricity generation. Ionic impurities, for example Ca⁺², and Zn⁺² can have a deleterious effect on the proton transport in polymer electrolyte membranes, see Okada et al J. Electrochem. Soc. Vol. 144, pp. 2744, (1997); and St-Pierre et. al, J. New Mat. Electrochem. Sys. Vol. 3 pp 99, (2000). In other applications, ionic contaminants can effect other processes such as wafer cleaning liquids used in semiconductor production which can lead to production of defective chips.

Embodiments of the present invention include cured elastomeric materials of high purity. In some embodiments, the cured elastomers do not contain amounts of extractable cations that would bind to a polymer electrolyte membrane in a fuel cell to an extent where the proton conduction of a fuel cell was degraded and could not produce useful amounts of current. In other embodiments, the cured elastomers have less than about 200 ng/cm² of extractable calcium. In some embodiments less than about 200 ng/cm² extractable calcium and zinc combined. In some embodiments less than about 225 ng/cm² extractable calcium, zinc, and magnesium combined. In other embodiments less than about 225 ng/cm² extractable calcium, zinc, sodium, and magnesium combined. In some embodiments, the cured elastomer is comprised of ethylene-propylene-diene terpolymers. In other embodiments the cured elastomer consists essentially of ethylene-propylene-diene terpolymers and a filler. Embodiments of the invention include low metal containing thermoset elastomers, for example low metal EDPM and TFE/PP (polytetrafluoroethylene/polypropylene) thermoset elastomers, that have excellent creep resistance and are orders of magnitude cleaner than conventional thermoset elastomers.

One embodiment of the invention is a composition comprising or including a peroxide curable monoolefin copolymer rubber, elastomer, or gum stock, a curing agent, and a filler, wherein the peroxide curable monoolefin co-polymer rubber, curing agent, and filler prior to curing includes a total amount of ionic material that is less than about 1000 μg/g, preferably the amount of leachable ionic material is less than about 1000 μg/g; even more preferably the amount of ionic material that interferes with the conductance of a polymer electrolyte membrane in a fuel cell is less that about (1000 μg ionic material)/(gram of composition). In some embodiments the peroxide curable monoolefin can be an ethylene propylene-diene terpolymer, a peroxide curable ethylene propylene copolymer, or any combination of these. The composition can further include a polyunsaturated coagent. Another embodiment of the invention is a cured thermoset elastomer obtained by curing any of these compositions. In some embodiments the elastomer is not a fluoroelastomer.

The ionic material, which is absent or substantially absent from the uncured composition or leached/extracted from the cured thermoset elastomer composition using an acid solution, can be characterized in that the extracted ionic material is soluble in the acid solution and or interferes with the ionic conduction of a polymer electrolyte membrane in a fuel cell. The ionic material may also be characterized as causing defects in semiconductor devices such as corrosion or formation of traps. The cured elastomer composition can be extracted and characterized for ionic material with a solvent that is not pure water. In some embodiments the amount of ionic material extracted from the cured thermoset elastomer with a aqueous acid is less than about 300 ng/cm² of extractable material.

In some embodiments the filler, curable monoolefin rubber, elastomer or gumstock, the curing agent, or any combination of these can be treated to remove extractable ionic material before curing. In some embodiments, the filler, curable monoolefin rubber, elastomer or gumstock, the curing agent, or any combination of these may be chosen to have an acceptably small amount of ionic material or compounds that could extract cations to provide a composition that can be formed into a cured elastomer and used in a seal. The seal can be for a fuel cell or other article. An acceptably small amount of ionic material is an amount would not make operation of a fuel cell impractical in terms of current or voltage produced.

One embodiment of the invention is a composition that can include or comprise an elastomer that includes at least one polymer selected from the group consisting of an ethylene-propylene-nonconjugated diene terpolymer, an ethylene-propylene copolymer, and any combination of these; a curing agent which can be an organic peroxide, or phenolic resin, or any mixture or combination of these; and at least one filler. The composition is absent sufficient cationic impurities that would degrade the ionic conduction of a polymer electrolyte membrane or makes a fuel cell comprising such membranes impractical for operation. The composition can be cured to form a cured thermoset elastomer that is absent sufficient cationic impurities to degrade the ionic conduction of a polymer electrolyte. In some embodiments the cured thermoset elastomer has less than about 200 ng/cm² of extractable calcium. In some embodiments the cured thermoset elastomer has less than about 200 ng/cm² extractable calcium and zinc combined. In some embodiments the cured thermoset elastomer has less than about 225 ng/cm² extractable calcium, zinc, and magnesium combined. In some embodiments, the cured thermoset elastomer has less than about 225 ng/cm² extractable calcium, zinc, sodium, and magnesium combined. These cured elastomers can be include in articles or an apparatus, for example but not limited to a fuel cell, a filter housing, a chemical drum, a seal for a transducer in a fluid conduit or bath, or other devices with seals that may be in contact with high purity fluids. In some embodiments the cured elastomer is not a cured fluoroelastomer or does not contain a fluoropolymer. In other embodiments, the cured elastomer does not contain silicone.

In some embodiments the polymer gumstock or curable elastomer is contained in an amount of about 100 parts by weight, and the filler, which can include carbon black or other material, can be in an amount of about 30 parts by weight, and curing agent which can be an organic peroxide is about 2 parts by weight. The composition can be formed and cured by compression molding at a temperature of from about 150° C. to about 180° C. for about one hour. Any cationic impurities, which can be trace metals extracted as ions from the cured composition, can be in an amount less than about 300 ng/cm² of composition. Preferably the extractable cationic impurities from the cured thermoset elastomer includes less than about 200 ng/cm² calcium and zinc combined.

The non-conjugated diene monomer terpolymerized to give the ethylene-propylene diene terpolymer can be selected from the group consisting of dicyclopentadiene, 4-hexadiene, ethylidene norbornene, and any combination including these. The curing agent can be an organic peroxide and can be selected from the group consisting of dicumyl peroxide, methyl-2,5-di(t-butyl-peroxy)hexane, dibenzoyl peroxide, 2,4-dichlorobenzyl peroxide, and combinations including these.

In some embodiments the ethylene-propylene-nonconjugated diene terpolymer, ethylene-propylene copolymer, any combination of these; the curing agent such as but not limited to an organic peroxide, or phenolic resin, or combinations of these, and/or at least one filler can be treated to remove extractable ionic material before curing. Alternatively one or more of these components can be chosen to have an acceptably small amount of ionic material or compounds that would form ionic impurities. These components can be combined to provide a composition that can be used in a seal for a fuel cell such that the seal does not significantly reduce the ionic conductance of the fuel cell's polymer electrolyte membrane.

One embodiment of the invention is an article that includes or comprises a seal for a conduit, transducer, electrode, a porous membrane containing device, or fuel membrane electrode assembly with one or more elastomeric seals, the seals comprising a peroxide or phenolic resin cured thermoset elastomer; and wherein the cured elastomer extracts less than about 300 ng/cm² of ionic material, the extractable material capable of decreasing the conductivity of a polymer electrolyte membrane in a membrane electrode assembly In some embodiments the cured elastomer in the article has less than about 200 ng/cm² of extractable calcium. In some embodiments the cured thermoset elastomer in the article has less than about 200 ng/cm² extractable calcium and zinc combined. In some embodiments the cured elastomer in the article has less than about 225 ng/cm² extractable calcium, zinc, and magnesium combined. In some embodiments, the cured elastomer in the article has less than about 225 ng/cm² extractable calcium, zinc, sodium, and magnesium combined. The cured elastomer in embodiments of the invention and an element of the article can comprise a cured unsaturated elastomer or a thermoplastic elastomer. In some embodiments the elastomer is not a fluoroelastomer or does not contain fluoroelastomer.

One embodiment of the invention is an article that can comprise a cured thermoset elastomer as a seal for a conduit, transducer, a seal for a chemical drum, a seal for an electrode, a seal for a porous membranes containing device like a filter, or seal in a fuel membrane electrode assembly. The one or more cured elastomers that comprise the seals of the article may comprise or optionally consist essentially of a peroxide or phenolic resin curing agent, a monoolefin copolymer containing elastomer, and filler that have been cured. The cured monoolefin copolymer elastomer extracts less than about 300 ng/cm² of extractable material. The extractable material may be characterized as an ionic material which would decrease the conductivity of a polymer electrolyte membrane in a membrane electrode assembly of a fuel cell. In some embodiments, the cured elastomer in the article has less than about 200 ng/cm² of extractable calcium. In some embodiments the cured thermoset elastomer in the article has less than about 200 ng/cm² extractable calcium and zinc combined. In some embodiments the cured thermoset elastomer in the article has less than about 225 ng/cm² extractable calcium, zinc, and magnesium combined. In some embodiments, the cured elastomer in the article has less than about 225 ng/cm² extractable calcium, zinc, sodium, and magnesium combined. In some embodiments, the monoolefin co-polymer is EPDM, EPM, or comprises a co-polymer including one or more of these. In some embodiments, the monoolefin co-polymer is EPDM, EPM, or consists essentially of a co-polymer including one or more of these. The extraction can be from an acidic solution and any ionic extractables are soluble in the solution.

One embodiment of the invention is a fuel cell stack with one or more thermoset elastomeric seals, the seals comprising peroxide or phenolic resin cured monoolefin copolymer rubber or gumstock with a filler. The cured monoolefin copolymer rubber extracts less than about 300 ng/cm² of extractable material, the extractable material capable of decreasing the conductivity of a polymer electrolyte membrane in the fuel cell.

Another embodiment of the invention is a composition consisting essentially of an organic peroxide curable monoolefin copolymer elastomer or gumstock, an organic peroxide, and a filler, wherein the organic peroxide curable monoolefin copolymer rubber, organic peroxide, and filler prior to curing have a total amount of ionic material in the composition that can be less than about 1000 μg/g. In some embodiments, the curable monoolefin elastomer is an ethylene propylene-diene terpolymer, an ethylene propylene copolymer, or any combination of these. Some embodiments of the invention include a cured thermoset elastomer obtained by curing these compositions. The composition as a cured elastomer can be formed into a seal and used in a device that contacts fluids used in fuel cells, used in a wafer cleaning apparatus, used as a seal for a chemical drum, or a seal for a transducer, conduit, a porous membrane filter device, or other structure in a fluid flow system where low ionic extractables are advantageous.

The level of extractable contaminant that would degrade a fuel cell or create defects in a semiconductor wafer is much lower than for other applications such as automotive hoses or weather stripping seals, in some cases 1 or more orders of magnitude lower. The temperature where the thermoset elastomeric seals in embodiments of the present invention are used are much different than for ink-jet printing ink bladder where it is typically organic contamination from the bladder that affects surface tension of the ink.

Advantageously, embodiments of the present invention can be prepared that cost less than fluoroelastomers. This can reduce costs in systems that use multiple seals or have large sealing surfaces such as fuel cells, wafer or substrate cleaning apparatus, wafer or substrate coating apparatus, wafer or substrate handling or storage equipment, seals for chemical drums, seals for joining conduits, or seals for transducers in fluid communication with a conduit or port.

Curing of elastomers can be impacted by impurities and additives in the fillers, gumstocks or elastomers, and other components that can be included in a cured elastomer. Trace amounts of basic materials such as ZnO, MgO in gumstocks or elastomers can alter the acidity of a composition that is being cured which can impact peroxide stability and the properties of the cured elastomer. Removing or reducing sources of ionic contaminants like ZnO, MgO, small molecule amines, mineral carriers and other contaminants in fillers, elastomers or gumstocks, peroxides or other additives can modify peroxide curing reaction and the properties of cured elastomers (compression set, tensile strength, hardness, and modulus) made from them. The inventors have surprisingly found that a curing agent comprising a peroxide or phenolic resin can be used to prepare at low cost, cured thermoset elastomers with a low concentration of ionic containing or leaching material. The specific properties of the embodiments of the cured elastomers such as creep resistance, compressive properties, temperature stability, adjustable or low water permeability make these cured elastomers useful for fuel cell seals, seals for semiconductor manufacturing equipment, or other applications. In part, other aspects, features, benefits and advantages of the embodiments of the present invention will be apparent with regard to the following description, appended claims and accompanying drawings.

Before the present compositions and methods are described, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “filler particle” is a reference to one or more filler particles and equivalents thereof known to those skilled in the art, and so forth. Unless defined otherwise, all technical and scientific terms used herein have the same meanings as commonly understood by one of ordinary skill in the art. Methods and materials similar or equivalent to those described herein can be used in the practice or testing of embodiments of the present invention. All publications mentioned herein are incorporated by reference. Nothing herein is to be construed as an admission that the invention is not entitled to antedate such disclosure by virtue of prior invention.

Embodiments of the present invention include cured elastomeric materials of high purity, compositions for making them, and articles comprising the cured elastomeric materials. Embodiments of the invention include cured elastomers that have less than 200 ng/cm² of calcium. In some embodiments, the cured elastomer is made from cross linked ethylene-propylene-diene terpolymers and can be free from cross linked fluoroelastomers or silicone elastomers. The cured elastomers in embodiments of the present invention may be used for seals including o-rings and gaskets.

Solid polymer type fuel cells can include two porous electrodes separated by an electrolyte material in the form of a membrane. The porous electrodes, can be made from a membrane (paper, polymeric porous membrane, or other suitable material) supporting a layer of a catalyst such as platinum, and the electrolyte material together form an assembly called a membrane electrode assembly (“MEA”). The MEA is located between two electrically conductive or, conveniently, graphite flow field plates. The graphite flow field plates supply fuel, typically in the form of a hydrogen containing fuel like hydrogen gas or methanol, and an oxidant, typically an oxygen containing material like air or oxygen, to the MEA. The graphite flow field plates also act to transmit current generated by the fuel cell stack to an external electrical circuit where it may be stored or otherwise used as described in U.S. Pat. No. 5,284,718 the contents of which are incorporated herein by reference in their entirety.

The membrane electrode and seal assemblies in the active section of the MEA can be essentially identical. Each membrane electrode and seal assembly can include elements such as a first layer comprised of a porous electrically conductive sheet material such as but not limited to a porous carbon fiber paper; a second layer comprised of an electrolyte material which is can be a solid polymer ion exchange membrane; a third layer comprised of a porous electrically conductive sheet material, and gaskets or other similar seals. The porous electrically conductive sheet material can be layers of carbon fiber paper which can support the membrane between them to form a consolidated membrane electrode assembly or MEA. The carbon fiber paper layers can each be treated with a catalyst on the surfaces adjacent and in contact with the membrane to form electrodes. The treated area coincides with the flow field of the flow field plates which help to carry the gases to the carbon fiber paper layers. The seals or gaskets for the MEA's preferably have low permeation to reduce evaporation of water and drying of the polymer electrolyte membrane and permit easy assembly and disassembly of the seals. Embodiments of the present invention include seals comprised of cured elastomers, cured rubbers, or cured gumstocks that have reduced amounts of acid extractable cations.

Types of elastomers or gumstocks that may be used with curing agents that comprise organic peroxides and or phenolic resins can separately include unsaturated elastomer stocks (gumstocks) like ethylene-propylene di-monomer (EPDM) rubber, ethylene-propylene rubber (EPR or EPM); vinyledene/hexafluoropropylene fluoroelastomers; vinyledene/hexafluoropropylene/tetrafluoroethylene fluoroelastomers; vinylidene/chlorotrifluoroethylene fluoroelastomers; tetrafluoroethylene/propylene (TEF/P) fluoroelastomers (such as Aflas from Asahi); butadiene rubber, natural rubber, polyisoprene, butadiene acrylonitrile rubber (NBR); styrene butadiene rubber (SBR), chloroprene rubber; chlorosulfonyl rubber; epichlorohydrin rubber; silicone rubbers, and combinations of these. Preferably the elastomers that may be used with the curing agent include ethylene-propylene di-monomer (EPDM) rubber, ethylene-propylene rubber (EPR or EPM), or combinations of these. Mixtures or combinations of elastomers that may be used to form cured thermoset elastomers in embodiments of the invention may be free or absent of silicone or fluoroelastomer.

In some embodiments the gumstock has less than about 200 parts per million of extractable calcium. In some embodiments the gumstock has less than about 200 parts per million extractable calcium and zinc combined. In some embodiments the gumstock has less than about 225 parts per million extractable calcium, zinc, and magnesium combined. In some embodiments, the gumstock has less than about parts per million extractable calcium, zinc; sodium, and magnesium combined.

EPDM is intended to mean a terpolymer containing ethylene and propylene in the backbone and a diene in the side chain. The ethylene and propylene monomers combine to form a chemically saturated, stable polymer backbone. A third, non-conjugated diene monomer can be terpolymerized in a controlled manner to maintain a saturated backbone and place the reactive unsaturation in a side chain available for curing or polymer modification chemistry. Ethylene-propylene copolymers or elastomers are called EPM. No particular limitation is placed on the diene monomer, for use in EPDM, but a diene monomer with 5 to 20 carbon atoms can be used. Non-limiting examples of the diene monomers include 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclo-pentadiene (DCP), 5-ethylidene-2-norbornene (ENB), 5-butylidene-2-norbornene, 2-methallyl-5-norbornene, 2-isopropenyl-5-norbornene and the like. These diene monomers may be used singly, or two or more monomers may be used in combination. Of the diene monomers listed above, it is preferred that dicyclopentadiene (DCP) and 5-ethylidene-2-norbornene (ENB) be used alone or in combination.

Thermoplastic elastomers or gum stocks that may be used in the present invention for peroxide and or phenolic resin curing may include but are not limited to polyethylene elastomers and elastomers or related olefinic elastomers, chlorinated polyethylene, ethylene/vinyl acetate copolymers, urethane elastomers with ester functionality.

Suitable curatives or curing agents generally are those which generate free radicals at curing temperatures used to make the cured elastomer. These curing agents can be pure liquids or solids and can exist in forms that exclude solid supports such as cation generating materials like calcium carbonate, kaolin clay, or other supports. Organic curing agents may include peroxides like dicumyl peroxide, tert-butylcumyl peroxide, benzoyl peroxide, dibenzoyl peroxide, diacylperoxide, n-butyl-4,4′-di(tert-butylperoxy)valerate; 1,3-1,4 bis(tert-butylperoxisopropyl)benzene, 2,5 dimethyl 2,5 di(tert-butylperoxyl) hexyne; 2,5 dimethyl 2,5 di(tert-butylperoxyl) hexane (a non-limiting example of a curing agent commercially available as VAROX DBPH from Vanderbuilt that is available as a liquid without a carrier); 1,1′-di(tert-butylperoxy)-3,3′5-trimethylcyclohexane, or any combination of these. Phenolic resins, another type of organic crosslinking or curing agent, can be substituted for traditional sulfur vulcanization chemistries. Phenolic resins as curing agents may include alkyl phenolics such as but not limited to octyl phenolic or tert-butyl phenolic, or bromomethyl alkylated phenolic resins (for example Dyphene 570) or any combination of these. Phenolic resins and organic peroxide curing agents may be used separately or as mixtures and combined with the elastomer and filler to form the cured elastomer.

In some embodiments, the peroxide vulcanizing or curing agent, which is mixed with the selected rubber gumstock or elastomer, can be chosen from, for example, 2,4-dichloro-benzoyl peroxide, benzoyl peroxide, 1,1-di-t-butylperoxy-3,3,5-trimethyl-cyclohexane, 2,5-dimethyl-2,5-dibenzoylperoxyhexane, n-butyl-4,4′-di-t-butylperoxy valerate, dicumyl peroxide, t-butylperoxy benzoate, di-t-butylperoxydiisopropylbenzene, t-butylcumyl peroxide, 2,5-dimethyl-2,5-di-t-butylperoxybexane, 2,5-dimethyl-2,5-di-t-butylperoxyhexene-3 and the like. These peroxides may be used singly, or two or more peroxides may be used in combination. Examples of the commercially available peroxide type vulcanizing agents are PERHEXA 3M of NOF Corporation, which is 1,1-di-t-butylperoxy-3,3,5-trimethylcyclohexane, PERCUMYL D of the same company, which is dicumyl peroxide, and PEROXYMONE F of the same company, which is 1,3-bis-(t-butylperoxyisoptopyl)benzene. Curing agents can be purified prior to use to reduce their metals or ionic impurity content such that sealing materials suitable for use in a fuel cell can be made.

The rubber composition of this invention can contain an antioxidant, for example but not limited to quinoline. The antioxidant is preferably employed in an amount not exceeding 3 parts by weight per 100 parts by weight of EPDM.

The rubber composition of this invention may further contain any other additive if it does not adversely affect the composition, specific properties, or its advantages as a seal. Other additives may include, a white reinforcing agent such as a stiffer polymer that is white and may include but is not limited to poly-paraphenylene terephthalamide fibers (Kevlar), polytetrafluoroethylene fibers (PTFE), polyetheretherketone fibers (PEEK), mixtures of these, or other such reduced metal containing fibers. Other additives may further include a vulcanization accelerator, process oil, a processing aid, lubricant, plasticizer, and a reactive monomer. Embodiments of the invention may also contain additives, preferably additives that are free or have low levels of ionic contaminants or have been treated to remove them. Non-limiting examples of these additives may include but are not limited to carbon black and or a variety of other organic additives such as accelerators, anti-oxidants, paraffinic softeners, anti-ozanants (See for example, “Elastomer Processing: Formulas and Tables” by Kleeman and Weber, the contents of which are incorporated herein by reference in its entirety). In some cases there may be few additional additives. For example, fluoroelastomer compounds could use an acid acceptor to process them, for example a high molecular weight polyamine that would not extract from the cured elastomer and bind to a polymer electrolyte membrane.

The composition may include a coagent. The coagent for example can be used where acids like HCl are released during curing. Examples of coagents can include 1,2-polybutadiene, unsaturated epoxies, combinations of these or their equivalents. These scavengers are advantageous over others like ZnO, MgO, and CaO which leave metal cations in the cured elastomer. Embodiments of the invention can include those compositions that are absent or free of metal containing coagents, and in some embodiments free of metal oxides such as ZnO, MgO, CaO, or combinations of these.

The seals can be formed into an o-ring, a gasket, a bead seal on one or more sides of a substrate, or other composite structure, or it may optionally be formulated as an adhesive by using low molecular weight co-polymers and short curing times. The seal has less than 300 ng/cm² of cationic impurities that can be extracted from the cured elastomer with an acid containing solution. The extractable impurities may initially exist as compounds or molecules in the cured elastomer that can form ions upon extraction or contact with an acid containing extraction solution or during use where a process fluid or other fluid contacts the cured elastomer. The extracted impurities can be characterized as those that can decrease the ionic conductivity of a polymer electrolyte membrane and or cause defects in semiconductor devices (cause corrosion, act as charge traps, or form other defects). In some embodiments of the cure elastomer of the present invention, the total sum of measured sodium, magnesium, aluminum, calcium, titanium, vanadium, chromium, zinc, copper, germanium, and barium metals, extracted from the cured elastomer as ions with a 5% nitric acid extraction solution (or other equivalent extraction solution) is less than about 300 ng/cm². The cured elastomer can also be characterized as comprising less than about 200 ng/cm² of extractable calcium; as comprising less than 200 ng/cm² of extractable calcium and zinc combined; as comprising less than about 225 ng/cm² extractable calcium, zinc, and magnesium combined; or as comprising less than about 225 ng/cm² extractable calcium, zinc, sodium, and magnesium combined.

Impurities that can decrease the ionic conductivity of a polymer electrolyte membrane can include cations such as alkali metals, alkaline earth metals, transition elements (such as Ag⁺, Ni⁺², Mn⁺², Cu⁺², Zn⁺², Cr⁺³ or others), rare earths (such as Al⁺³, La⁺³ or others), ammonium derivatives such as but not limited to RₙNH₄₋ₙ⁺ where R can be H, or an organic radical such as an aliphatic, aromatic, or other like CH₃, C₂Hs, C₃H₇, C₄H₉), or complexes.

The co-polymer, elastomer, or gumstock, which may be a mixture is cured to an extent that makes it useful as a seal, for example a gasket, a tape, an o-ring, or other sealing article. The extent of curing to form a cured thermoset elastomer can be determined by extraction of organic material with an organic liquid like xylene or by detection of volatile organics (VOCs) using GC/MS. Where an undesirable amount of residual peroxide or decomposition product such as an alcohol is detected in the cured elastomer, the cured elastomer may be further treated with a post cure bake. Where an undesirable amount of residual peroxide or decomposition product such as an alcohol is detected in the cured elastomer, the cured elastomer may be further treated with a post cure bake at a reduced pressure such as in a vacuum oven.

The organic peroxide, phenolic resin, or combination of these used as a curing agent can be completely consumed by the vulcanization or curing reaction. The amount of residual peroxide in the cured rubber can also be determined using an iodometric titration. Most organic peroxides are reduced by iodide ions in acid solution, yielding one mole of iodine per equivalent of peroxide. This reaction is the basis of the well-known technique of iodometric titration for quantitation of organic peroxides in which the liberated iodine is titrated with a standard solution of sodium thiosulfate. Because the cured elastomer is a solid, thorough mixing is used to react with peroxide within the sample matrix. An accepted iodometric titration method for fats and oils is American Oil Chemists' Society Official Method Cd 8-53. This method can be further modified to render it more suitable to an EPDM system.

Peroxide and or phenolic resin cured elastomers, for example cured monoolefin copolymer base elastomers can be used in a number of applications due to their ability to withstand high temperatures and aggressive chemicals like ozone, as well as the ability of the monoolefine copolymer gum to be processed using standard elastomer processing equipment. Peroxide and or phenolic resin cured monoolefin copolymer based elastomers can be used in the semiconductor industry in the chip manufacturing process where they may be used for seals in substrate handling, substrate coating, substrate cleaning equipment. During chip manufacturing processes, the cured monoolefin copolymer elastomers with low cationic extractables can be exposed to high temperature and aggressive chemicals.

The amount of the peroxide and or phenolic resin comprising curing agent added to the elastomer and filler for curing can be in the range of about 0.5 to 10 parts by weight and, more preferably, 2 to 5 parts by weight, based on 100 parts by weight of the selected rubber gumstock or elastomer. The unit, part or parts by weight, are referred to as “part” or “parts” for the convenience of explanation. If the amount of curing agent is too small, sufficient curing is not attained so that the resultant rubber or cured elastomer has poor sealing properties. If the amount of curing agent is too high, the resultant rubber or cured elastomer can become too hard to form a useful seal. In some embodiments the polymer gumstock or elastomer is contained in an amount of about 100 parts by weight, and the filler, which can include carbon black, can be in an amount of about 30 parts and the peroxide is about 2 parts.

The composition comprising elastomer, filler and curing agent can be cured at a temperature of from about 120° C. to about 180° C., in some embodiments the composition can be cured at a temperature of from about 140° C. to about 160° C. A combination of temperatures may be used and can include increasing and decreasing temperature ramps used during the process. The composition can be heated for about 0.25 hours up to about 4 hours to cure the composition. In some embodiments the composition may be heated for about 0.75 to about 1.25 hours. The choice of temperature and time can be chosen to provide a cured elastomer with compression and creep resistance suitable for sealing fuel cells or for sealing fluid containing conduits at temperatures and pressures used in wafer or flat panel coating, cleaning, etching, or stripping processes. Longer cure times may be used to ensure complete reaction and removal of volatile by-products. The composition may be cured and compression molded.

The filler which may be mixed with component the rubber gumstock or elastomer and curing agent can include carbon, for example but not limited to, carbon black, buckey-balls (C₆₀), single or multi-walled carbon nanotubes, layered materials like graphite, or combinations including any of these. These fillers may be used singly, or two or more fillers may be used in combination to modify the strength and permeation properties of the cured elastomer or cured rubber. In view of its mechanical properties and molding properties, the filler can have a mean particle diameter of 0.05 to 20 microns and, more preferably, 0.1 to 10 microns. Where the filler or additive comprises acid groups, the amount of these materials can be adjusted so that they do not decompose or adversely affect the curing agent.

The filler can be cleaned or extracted prior to being mixed with the gumstock and peroxide or other curing agent to remove, reduce, or eliminate extractable cations. For example the filler can be leached with an aqueous solution of strong mineral acid like HCl or nitric acid and washed with deionized water and dried prior to mixing with the gumstock and curing agent. The filler can be washed until any acid that could decompose the peroxides or inhibit free radical formation and adversely affect the curing reaction has been reduced to a sufficient level.

The amount of the filler to be added can be in the range of 10 to 130 parts and, in some embodiments from about 20 to about 50 parts, and in still other embodiments from 30 to 50 parts based on 100 parts of the selected curable elastomer, curable rubber, or curable gumstock. If the filler is less than about 20 parts, the resultant sealing material can have high gas permeation. If the filler is too high, greater than about 130 parts, the strength of the rubber can be reduced.

The cured thermoset elastomer can be prepared by mixing components including the elastomer or gumstock, curing agent, and filler with each other and, optionally, with other components or additives to form a curable composition, and then kneading the mixture using a kneading machine such as a two roll mill, a kneader, a Banbury mixer or the like. Mixing can be performed in corrosion resistant stainless steels or other materials. A testpiece of the cured elastomer can be formed from each curable composition, and evaluated for its physical properties in use conditions such as but not limited to hot air aging resistance, water permeation, compression set, and or flex life.

A fluid in contact with the high purity sealing material prepared in embodiments of the invention will extract less metal ions from that seal during use compared to similar seals made using metal containing acid scavengers like ZnO and filters like TiO₂. Compositions in embodiments of the present invention can eliminate metal ions that can affect fuel cell electrolytes and semiconductor process related chemicals and wafers. Further, embodiments of the present invention are absent organosulfur or organophosphorous comprising vulcanizing agents. Compositions in embodiments of the present invention are free of added anions such as sulfate and phosphate ions from organosulfur or organophosphorous based vulcanizing agents. Such a gasket or other sealing article can be characterized by extraction using acidified water. Furthermore, the low-contaminate sealing material can be extracted such that the solvent has a total metal ion concentration of 300 ng/cm² or less. In some embodiments the cured elastomer has less than about 200 ng/cm² of extractable calcium. In some embodiments the cured elastomer has less than about 200 ng/cm² extractable calcium and zinc combined. In some embodiments the cured elastomer has less than about 225 ng/cm² extractable calcium, zinc, and magnesium combined. In some embodiments, the cured elastomer has less than about 225 ng/cm² extractable calcium, zinc, sodium, and magnesium combined. Thus, even when a fluid is allowed to contact the low-contaminate article, the fluid is less likely to be contaminated by the metal ions. High purity sealing materials in some embodiments of the invention are sufficiently low in their content of metal ions such that they are suitable for use in the semiconductor industry. Remaining metal cations refers to metal ions that can be analytically found after subjecting the polymer sample to an acid extraction.

Embodiments of the present invention include cured thermoset elastomeric materials of high purity. In some embodiments, the cured elastomers do not contain amounts of extractable cations that would bind to a polymer electrolyte membrane in a fuel cell to an extent where the proton conduction of a fuel cell was degraded. This degradation may be assessed for various elastomeric materials in embodiments of the invention compared to control materials by making a fuel cell stack with gaskets of each material and evaluating the lifetest for the fuel cells over extended periods of time, for example 1000 hours or more. The cells with the different seal material can be run under similar current density, humidity level, temperature and other conditions. The cell voltage for the control and test fuel cell can be monitored over time and correlated with the composition of the gasket. Cured elastomeric materials in embodiments of the present invention can be made into gaskets for a fuel cell. A fuel cell utilizing such gaskets are of sufficient purity and or gas permeation resistance (water vapor, oxidant, fuel, or any combination of these) that the fuel cell can have an average cell voltage degradation rate of less than about 100 microvolts/hour, in some embodiments less than 50 microvolts/hour, and in still other embodiments less than 10 microvolts/hour.

The seals can have low gas permeation which can be made through choice of filler, elastomer and curing time. The low gas permeation can be advantageous in fuel cells to reduce evaporation of fuel, oxidant, and/or water vapor. Prevention of water loss from the stack helps reduce drying of the polymer electrolyte membrane. In process equipment where such curable elastomeric seals are used, the low gas permeation can reduce the transport of hazardous vapors such as HCl or HF. In some embodiments the cured thermoset elastomers can be formed into seals that have low permeation to reduce evaporation of water and drying of the polymer electrolyte membrane and where extraction of the cured elastomer provides a total metal ion concentration of 300 (ng metal)/(cm² of sealing material) or less, preferably total metal ion concentration of 300 (ng metal)/(cm² of sealing material) or less for the extractable metals Zn, Ca, Mg, and sodium.

The curable composition can be conveniently processed into an article such as but not limited to a tape, gasket, a bead seal on one or more surfaces of a substrate, or an o-ring, by using known molding techniques and curing the elastomer composition by subjecting it to heat and pressure. Thereafter the article may be subjected to a post cure cycle. The cured elastomers obtained in this invention may be suitable for use in fuel cells, in the manufacture of pharmaceuticals, or in the manufacture of semiconductor and display devices and in particular in sealing of conduits, transducers, and fluid handling devices used in wafer, flat panel, and chip production. The cured elastomers are useful in applications where extracted or leached cations from the cured elastomers could interfere with the ionic conduction of a material. In particular, the cured elastomer formed in embodiments of the invention has a very low level of metal ions or other cations remaining. Embodiments of the invention used as a gasket for fuel cells precludes or reduces generation of contaminants, such as cations, by the reaction with the material constituting the gasket body, allowing high generating efficiency of the fuel cell.

### EXAMPLE 1

This example illustrates elastomer comprising compositions that can be cured to give low extactable materials suitable for use in semiconductor or fuel cell sealing applications. Contaminants can interfere with fuel cell performance. For example, metal cations can bind with the active sites in a fuel cell membrane, reducing performance (sites for conduction of protons). Metal impurities can be introduced into the stack by fuels, oxidants, or materials of construction. Materials of construction can include seals or gasket materials. These materials are traditionally processed with an array of metal oxide or metal salts that are intentionally added to aid in crosslinking reactions or to prevent scorch.

Instead of traditional sulfur cross linking chemistry that combines sulfur with metal salts, such as calcium stearate and zinc oxide, this example illustrates that it is possible to create metal free cured elastomeric compounds by using organic based curing agents, especially those having low levels of metals organic peroxides (eg. Dicumyl peroxide). These peroxides can be used to create metal free cross linked elastomers such as EPDM or FKM.

Test cured thermoset elastomer compounds were made by the following general procedure. 100 parts of EPDM gum stock, 30 parts of carbon black, and 2 parts of Varox peroxide that were mixed on a two roll mill. Sheets were compression molded for one hour at 150 degrees Celsius.

A summary of the metal extractables of a cured EPDM thermoset elastomer in an embodiment of the present invention compared to typical values for standard EPDM and Viton® gaskets is given in the Table 1 below. Materials were extracted for five days in 5% nitric acid at room temperature and then analyzed by inductively coupled plasma/mass spectroscopy (ICP/MS). The values in the Table 1 are in ng/cm².

TABLE 1

| | Example 1 | Typical EPDM | Typical Viton ® |
|---|---|---|---|
| | (ng/cm²) | (ng/cm²) | (ng/cm²) |
| Sodium | <5.7 | >65,000 | 43 |
| Magnesium | 13.1 | 2850 | 6724 |
| Aluminum | 31 | >28,500 | 131 |
| Calcium | 151 | 8766 | 10,269 |
| Titanium | 0.2 | 224 | 2.2 |
| Vanadium | 0.09 | 176 | N/A |
| Chromium | 3.4 | 50 | 0.9 |
| Zinc | 40.8 | >28,500 | 125 |
| Copper | 11.3 | 2200 | 12.9 |
| Germanium | 0.7 | 19,600 | 2.4 |
| Barium | 28.8 | 272 | 2.9 |

The elastomeric material of the example contained less total extractables for the metal ions shown in Table 1 than either the typical EPDM or the Viton®. The Viton® sample had less extractable chromium and barium than example 1. Overall the cured elastomeric material of the example contained less extractable total metal ions, and in particular contained less magnesium, calcium, and zinc. For the measured ions sodium, magnesium, aluminum, calcium, titanium, vanadium, chromium, zinc, copper, germanium, barium, the cured elastomer in an embodiment of the present invention had a total metal extractables of less than about 300 ng/cm², typical EPDM had at least 154,000 ng/cm², while the Viton® had at least 17,000 ng/cm² of these impurities. The composition of the present invention included less than about 200 ng/cm² of extractable calcium; less than about 200 ng/cm² of extractable calcium and zinc combined; less than about 225 ng/cm² extractable calcium, zinc, and magnesium combined; less than about 225 ng/cm² extractable calcium, zinc, sodium, and magnesium combined.

### EXAMPLE 2

This example illustrates the preparation of cured elastomers that are embodiments of the present invention using different peroxide curing agents (Varox DBPH and Vul Cup). The impurity levels of the peroxide curing agents and cured elastomers made from them (by digestion with concentrated nitric acid and extraction (six days) with 5% nitric acid) are given in Table 2.

TABLE 2

| | Digestions | | | | Extractions | |
|---|---|---|---|---|---|---|
| | Peroxides | | Cured Elastomer | | Cured Elastomer | |
| | Varox | Vulcup | Varox | Vulcup | Varox | Vulcup |
| Element | (ppm) | (ppm) | (ppm) | (ppm) | (ppm) | (ppm) |
| Boron | 46.238 | 42.481 | 55.146 | 56.941 | 1.105 | 1.347 |
| Sodium | 0.821 | 0.821 | 179.406 | 182.191 | 5.743 | 5.743 |
| Magnesium | 0.033 | 0.033 | 1.589 | 1.945 | 13.130 | 8.962 |
| Aluminum | 1.362 | 1.225 | 10.062 | 10.125 | 31.060 | 28.797 |
| Potassium | 59.866 | 40.148 | 80.196 | 73.732 | 29.085 | 29.085 |
| Calcium | 160.385 | 156.918 | 188.807 | 196.695 | 150.996 | 197.364 |
| Scandium | 0.601 | 0.609 | 0.691 | 0.750 | 0.179 | 0.357 |
| Titanium | 0.377 | 0.377 | 0.377 | 0.377 | 0.253 | 0.440 |
| Vanadium | 0.007 | 0.006 | 2.472 | 2.547 | 0.092 | 0.049 |
| Chromium | 2.009 | 1.728 | 2.193 | 2.068 | 3.454 | 2.756 |
| Manganese | 0.145 | 0.190 | 0.725 | 0.719 | 2.106 | 1.577 |
| Iron | 9.363 | 9.363 | 16.694 | 10.883 | 194.138 | 125.572 |
| Cobalt | 0.005 | 0.005 | 0.033 | 0.028 | 0.301 | 0.164 |
| Nickel | 0.014 | 0.014 | 0.326 | 0.248 | 9.921 | 7.113 |
| Zinc | 0.182 | 0.182 | 6.281 | 8.330 | 40.798 | 31.450 |
| Copper | 0.012 | 0.012 | 0.248 | 0.218 | 11.306 | 7.071 |
| Gallium | 0.007 | 0.003 | 0.098 | 0.237 | 2.193 | 2.036 |
| Germanium | 0.009 | 0.009 | 0.116 | 0.187 | 0.729 | 0.557 |
| Arsenic | 0.005 | 0.005 | 0.010 | 0.012 | 0.012 | 0.012 |
| Bromine | 3.966 | 4.294 | 9.371 | 11.580 | 5.108 | 5.108 |
| Strontium | 0.003 | 0.003 | 0.023 | 0.051 | 0.547 | 0.511 |
| Zirconium | 0.002 | 0.002 | 0.007 | 0.002 | 0.102 | 0.086 |
| Molybdenum | 0.010 | 0.010 | 0.021 | 0.014 | 0.056 | 0.038 |
| Silver | 0.002 | 0.002 | 0.002 | 0.007 | 0.432 | 0.414 |
| Cadmium | 0.008 | 0.008 | 0.008 | 0.008 | 0.184 | 0.216 |
| Tin | 0.006 | 0.032 | 0.041 | 0.108 | 1.441 | 3.606 |
| Antimony | 0.001 | 0.001 | 0.007 | 0.004 | 0.097 | 0.101 |
| Iodine | 1.262 | 1.379 | 0.915 | 1.144 | 3.619 | 3.982 |
| Barium | 0.072 | 0.008 | 1.013 | 2.637 | 28.864 | 27.004 |
| Samarium | 0.006 | 0.006 | 0.006 | 0.006 | 0.221 | 0.153 |
| Tungsten | 0.006 | 0.008 | 0.011 | 0.009 | 0.093 | 0.092 |
| Lead | 0.002 | 0.002 | 0.085 | 0.067 | 1.791 | 1.746 |
| Bismuth | 0.001 | 0.001 | 0.001 | 0.001 | 0.088 | 0.094 |

The cured elastomers were made by procedures similar to those in Example 1. The results show that cured elastomers having impurity levels less than about 600 ppm combined for the species listed in Table 2, and in particular the elements Na, Mg, Al, K, Ca, Fe, Zn, and Ba, by digestion can be made and indicates that the curable elastomer, curing agent and filler used to make the cured elastomer can have cationic impurities less than about 1000 [symbol] g/g (1000 ppm). The cured elastomers in this example included less than about 500 ng/cm² combined for the elements listed in Table 2 and in particular the elements Na, Mg, Al, K, Ca, Fe, Zn, and Ba, by extraction. The results further show that curing agents like organic peroxides that have impurity levels less than about 300 ppm combined for the species listed in Table 2, and in particular the elements Na, Mg, Al, K, Ca, Fe, Zn, and Ba, (by digestion) can be used to make curable elastomers with low impurities.

The cured elastomers of this example included less than about 200 ng/cm² of extractable calcium; less than about 230 ng/cm² of extractable calcium and zinc combined; less than about 250 ng/cm² extractable calcium, zinc, and magnesium combined; less than about 250 ng/cm² extractable calcium, zinc, sodium, and magnesium combined.

### EXAMPLE 3

This example illustrates examples of low impurity curable elastomers or gumstocks (samples ID No. 1040, 1320, and 1440). Sample 1040 was used to make an embodiment of a cured elastomer of the present invention similar to that provided in Example 1. The impurity levels of the curable elastomers were determined by digestion with concentrated nitric acid and are given in Table 3.

The results illustrate that curable elastomers having impurity levels less than about 250 ppm combined for the species listed in Table 3, and in particular the elements Na, Mg, Al, K, Ca, Fe, Zn, and Ba, can be used to make low impurity cured elastomers.

TABLE 3

| | 1040 avg-control | 1320 avg-control | 1440 avg-control |
|---|---|---|---|
| Elements | (ppm) | (ppm) | (ppm) |
| Lithium | 0.003 | 0.003 | 0.003 |
| Boron | 0.684 | 0.662 | 0.827 |
| Sodium | 2.929 | 2.929 | 2.929 |
| Magnesium | 0.473 | 1.585 | 0.436 |
| Aluminum | 4.516 | 2.305 | 4.750 |
| Calcium | 183.960 | 170.999 | 201.209 |
| Scandium | 0.681 | 0.0627 | 0.723 |
| Titanium | 0.161 | 0.063 | 0.139 |
| Vanadium | 1.392 | 0.391 | 1.423 |
| Chromium | 1.719 | 1.456 | 1.719 |
| Manganese | 0.121 | 0.121 | 0.121 |
| Cobalt | 0.017 | 0.017 | 0.017 |
| Nickel | 4.037 | 0.091 | 0.155 |
| Zinc | 0.484 | 0.463 | 0.197 |
| Copper | 0.391 | 0.099 | 0.145 |
| Gallium | 0.009 | 0.007 | 0.010 |
| Germanium | 0.013 | 0.013 | 0.013 |
| Arsenic | 0.006 | 0.006 | 0.006 |
| Bromine | 3.473 | 2.604 | 3.930 |
| Strontium | 0.011 | 0.010 | 0.010 |
| Zirconium | 0.020 | 0.024 | 0.015 |
| Niobium | 0.001 | 0.001 | 0.001 |
| Molybdenum | 0.025 | 0.006 | 0.006 |
| Silver | 0.033 | 0.004 | 0.004 |
| Cadmium | 0.013 | 0.013 | 0.013 |
| Tin | 0.031 | 0.004 | 0.009 |
| Antimony | 0.014 | 0.002 | 0.038 |
| Iodine | 0.255 | 0.079 | 0.111 |
| Barium | 0.050 | 0.041 | 0.064 |
| Tungsten | 0.004 | 0.004 | 0.004 |
| Lead | 0.002 | 0.026 | 0.011 |
| Bismuth | 0.007 | 0.007 | 0.007 |

Although the present invention has been described in considerable detail with reference to certain preferred embodiments thereof, other versions are possible. Therefore the spirit and scope of the appended claims should not be limited to the description and the preferred versions contain within this specification.

What is claimed is:

1. A composition comprising:
a monoolefin copolymer,
a curing agent;
a filler, wherein the monoolefin copolymer, curing agent, and filler prior to curing includes a total amount of ionic material that is less than about 1000 μg/g.

2. The composition of claim 1 wherein the monoolefin copolymer is chosen from the group consisting of an ethylene propylene-diene terpolymer, an ethylene propylene copolymer, and combinations of these.

3. A thermoset elastomer obtained by curing the composition of claim 1.

4. An article comprising the thermoset elastomer of claim 3.

5. The composition as in claim 1 or 3 wherein the ionic material is extracted using an acid solution.

6. The composition of claim 1 wherein the ionic material is extracted with a solvent that is not pure water.

7. The composition of claim 1 wherein the ionic material extracted from the cured elastomer is less than about 300 ng/cm² of extractable material, said extractable material characterized in that it decreases the conductivity of a polymer electrolyte membrane in a membrane electrode assembly of a fuel cell.

8. The composition as in claim 1 or 3 wherein the curing agent is a organic peroxide absent a mineral support.

9. A composition comprising:
an elastomer gumstock that includes at least one polymer selected from the group consisting of an ethylene-propylene-nonconjugated diene terpolylmer, an ethylene-propylene copolymer, and combinations of these;
a curing agent comprising an organic peroxide; and
at least one filler;
said composition including less than about 1000 μg/g cationic impurities that would degrade the ionic conduction of a polymer electrolyte membrane of a fuel cell.

10. The composition according to claim 9, wherein the elastomer gumstock is contained in an amount of about 100 parts by weight, and the filler is carbon black in an amount of about 30 parts and the peroxide is about 2 parts.

11. A composition comprising the composition of claim 9 cured by compression molding at a temperature of from about 150° C. to about 180° C. for about one hour.

12. The composition of claim 11 wherein trace metals extracted as ions from the cured composition is in an amount less than 300 ng/cm².

13. The composition of claim 11 wherein trace metals extracted from the cured composition includes less than 200 ng/cm² calcium and zinc combined.

14. The composition of claim 9 wherein the ethylene-propylene non-conjugated diene terpolymer is selected from the group consisting of dicyclopentadiene, 4-hexadiene, ethylidene norbornene, and combinations including these.

15. The composition of claim 9 wherein said organic peroxide is selected from the group consisting of dicumyl peroxide, methyl-2,5-di(t-butyl-peroxy)hexane, dibenzoyl peroxide, 2,4-dichlorobenzyl peroxide, and combinations of these.

16. The composition of claim 9 wherein the filler has been treated to remove extractable ionic material from the filler.

17. The composition of claim 9 wherein said filler comprises carbon.

18. An article comprising the composition of claim 11.

19. An article comprising:
A membrane electrode assembly with one or more elastomeric seals, said seals comprising a cured elastomer and filler formed from a support free organic peroxide; and
wherein the cured elastomer extracts less than about 200 ng/cm² of extractable calcium into an acid containing extraction solution.

20. The article of claim 19 wherein the cured elastomer comprises a cured unsaturated elastomer or a thermoplastic elastomer.

21. The article of claim 19 wherein the elastomer is not a fluoroelastomer.

22. An article comprising:
A membrane electrode assembly with one or more elastomeric seals, said seals comprising peroxide or phenolic resin cured monoolefin copolymer elastomer with a filler; and
wherein the cured monoolefin copolymer elastomer extracts less than about 300 ng/cm² of extractable material, wherein said extractable material is characterized as being capable of decreasing the conductivity of a polymer electrolyte membrane in the membrane electrode assembly of a fuel cell.

23. The article of claim 22 wherein the monoolefin co-polymer elastomer is EPDM.

24. The article of claim 22 wherein the cured monoolefin co-polymer elastomer includes EPM.

25. The article of claim 22 wherein said extraction is from an acidic solution and the extractables include cations.

26. An article comprising:
A fuel cell stack with one or more thermoset elastomeric seals, said thermoset elastomeric seals comprising peroxide or phenolic resin cured monoolefin copolymer elastomer; and
wherein the cured monoolefin copolymer elastomer extracts less than about 300 ng/cm² of extractable material, said extractable material capable of decreasing the conductivity of a polymer electrolyte membrane in the fuel cell stack.

27. A composition consisting essentially of:
a monoolefin copolymer elastomer,
a peroxide curing agent; and
a filler, wherein the monoolefin copolymer elastomer, curing agent, and filler prior to curing have a total amount of ionic material in the composition that is less than about 1000 μg/g.

28. The composition of claim 27 wherein the monoolefin copolymer is an ethylene propylene-diene terpolymer.

29. An thermoset elastomer obtained by curing the composition of claim 27.

30. The composition of claim 27 wherein said ionic material decreases the conductivity of a polymer electrolyte membrane in a fuel cell.

31. A composition comprising:
a cured monoolefin copolymer rubber; and
a filler, said composition extracts less than about 200 ng/cm² of calcium when contacted with an acidic extraction solution.

32. The composition of claim 31 where the composition extracts less than about 200 ng/cm² calcium and zinc combined.

33. The composition of claim 31 wherein the composition extracts less than about 225 ng/cm² calcium, zinc, and magnesium combined.

34. The composition of claim 31 where the composition extracts less than about 225 ng/cm² calcium, zinc, sodium, and magnesium combined.

35. A composition comprising:
a monoolefin copolymer elastomer,
a curing agent; and
a filler, said monoolefin copolymer elastomer, filler, and curing agent combined at a temperature of from about 130° C. to about 170° C. to form a cured elastomer.

36. The composition of claim 35 wherein the monoolefin copolymer elastomer, curing agent, and filler prior to curing have a total amount of ionic material in the composition that is less than about 1000 μg/g.

37. The composition of claim 35 where the composition extracts less than about 200 ng/cm² calcium and zinc combined into an acid containing extraction solution.

38. The composition of claim 35 wherein the composition extracts less than about 225 ng/cm² calcium, zinc, and magnesium combined into an acid containing extraction solution.

39. The composition of claim 35 where the composition extracts less than about 225 ng/cm² calcium, zinc, sodium, and magnesium combined into an acid containing extraction solution.

40. The composition of claim 35 where the filler is carbon black.
